(19) United States
(12) Patent Application Publication
(10) Pub. No.: US 2017/0312932 A1
(43) Pub. Date: Nov. 2, 2017

(54) UNIVERSAL PERFORATION SYSTEM FOR INSTALLATION ON A BINDING MACHINE

(71) Applicant: Emilio Carlos LOPEZ PEREZ, Distrito Federal (MX)

(72) Inventor: Emilio Carlos LOPEZ PEREZ, Distrito Federal (MX)

(21) Appl. No.: 15/256,946

(22) Filed: Sep. 6, 2016

Related U.S. Application Data
(63) Continuation-in-part of application No. 14/357,223, filed on May 9, 2014, now abandoned.

(51) Int. Cl. B26F 1/14; B42B 5/12; B42B 9/00

(52) U.S. Cl. CPC B26F 1/14; B42B 9/00; B42B 5/12; B26F 2210/02; B42P 2241/08

(57) ABSTRACT

The present invention relates a perforation system to be installed on a binding machine, the perforation system including a first elongated platform; a second elongated platform aligned with the first elongated platform; vertical bars to vertically connect the first elongated platform with the second elongated platform; a third elongated platform having a first end fixed to the second elongated platform and a second end secured to a surface on the binding machine; the first elongated platform includes holes and a punch passing through each hole, the holes and the punches have a shape with a length greater than a width; the second elongated platform includes guiding holes aligned with the holes and punches of the first platform, the guiding holes have a shape with a length greater than a width; the third elongated platform includes a row of perforations having a shape with a length greater a width; the holes, punches, guiding holes, and perforation have the same shape; the first elongated platform has a length, width, and thickness; the second elongated platform has a length, a width, and a thickness equal to the length, width, and thickness of the first elongated platform; and the third elongated platform has a length, a width, and a thickness greater than the length, width, and thickness of the first and second elongated platforms.

### CROSS REFERENCE TO RELATED APPLICATION

This application is a Continuation-In-Part of patent application Ser. No. 14/357,223, filed May 9, 2014, entitled Universal Perforation System for Installation on a Binding or Spiral-binding Machine Capable of Binding Using any Binding System, pending, which is a US National Stage Entry of PCT/MX2011/000135, filed Nov. 9, 2011, under the International Convention.

### FIELD OF THE INVENTION

The present invention relates to a perforation system and more particularly to a perforation system that can be installed on an existing binding machine to make different types of binding methods using the same machine.

### BACKGROUND OF THE INVENTION

Recently, the use of binding machines has increased considerably and the consumers are looking to do more with less. The known binding machines include a perforation system and a binding system. Unfortunately, the known perforation systems are configured to handle only one type of perforation format (shape—round, oval, oblong, square). Thus, in order to have the capability to bind papers with different perforation formats, separate binding machines are required.

As can be seen, having several binding machines in the same office limits the office space and increases the cost.

Therefore, it is necessary to provide a perforation system for a binding machine that allows to produce different types of binding formats using the same punching system to save space and cost to the consumer.

### SUMMARY OF THE INVENTION

The present invention relates to a universal perforation system for a binding machine, which alone can perforate the stacked paper with one kind of punch. This universal perforation system allows 20 existing binding formats to be done with just one machine. This universal perforation system standardizes, unifies, and simplifies 20 different methods into one. It is the only binding system with a perforations having longer than wide shaped form on all the perforations and the punches. Its unique longer than wide shaped form (oblong) and pitch allows to be used with 20 binding types using just one machine.

The present invention relates to a perforation system adapted to be installed on a binding machine, the perforation system including a first elongated platform; a second elongated platform aligned with the first elongated platform; vertical bars to vertically connect the first elongated platform with the second elongated platform; a third elongated platform having a first end fixed to the second elongated platform and a second end secured to a surface on the binding machine; the first elongated platform includes holes and a punch passing through each hole, the holes and the punches have a shape with a length greater than a width; the second elongated platform includes guiding holes aligned with the holes and punches of the first platform, the guiding holes have a shape with a length greater than a width; the third elongated platform includes a row of perforations having a shape with a length greater a width; the holes, punches, guiding holes, and perforation have the same shape; the first elongated platform has a length, width, and thickness; the second elongated platform has a length, a width, and a thickness equal to the length, width, and thickness of the first elongated platform; and the third elongated platform has a length, a width, and a thickness greater than the length, width, and thickness of the first and second elongated platforms.

In addition, the present invention relates to a perforation system adapted to be installed on a binding machine, the perforation system including: a first elongated platform; a second elongated platform aligned with the first elongated platform; vertical bars to vertically connect the first elongated platform with the second elongated platform; a third elongated platform having a first end fixed to the second elongated platform and a second end secured to a surface on the binding machine; a perforation selector mechanism operatively connected to the punches, the perforation selector mechanism selects the number of punch holes on a paper; the first elongated platform includes holes and a punch passing through each hole; the second elongated platform includes guiding holes aligned with the holes and punches of the first platform; the third elongated platform includes a row of perforations having a shape with a length greater a width; the first elongated platform has a length, width, and thickness; the second elongated platform has a length, a width, and a thickness equal to the length, width, and thickness of the first elongated platform; and the third elongated platform has a length, a width, and a thickness greater than the length, width, and thickness of the first and second elongated platforms.

### BRIEF DESCRIPTION OF THE DRAWINGS

For a better understanding of the present invention, this is described based on a preferred modality illustrated in figures that accompany this description and where:

FIG. 1 is a perspective side exploded view of a perforation system according to an embodiment of the present invention;

FIG. 2a is a top view of a first elongated platform of the perforation system of FIG. 1;

FIG. 2b is a top view of a second elongated platform of the perforation system of FIG. 1;

FIG. 2c is a top view of a first elongated platform of the perforation system of FIG. 1; and

FIG. 3 is an exploded view of the perforation system of the present invention in a non-operational position and the perforation selector system of the present invention.

### DETAILED DESCRIPTION OF THE INVENTION

The present invention is described based on a preferable embodiment in which is to be understood that the invention is not limited in its application to the construction details and the arrangement of the components specified in the presentation of reception or illustrated in the drawings.

It is mentioned, unless otherwise specified, that all of the scientific or technical terms used in this document have the same meaning that people with knowledge of the arts commonly have of the invention. The methods and examples provided in this document are illustrative and not intended to be a limitation.

The universal perforation system can be incorporated to any binding machine regardless of whether it is manual or automatic.

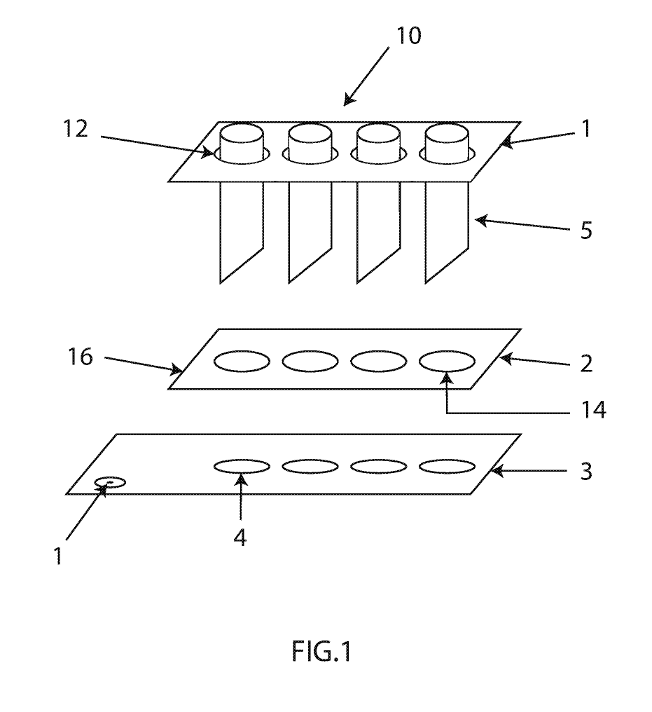

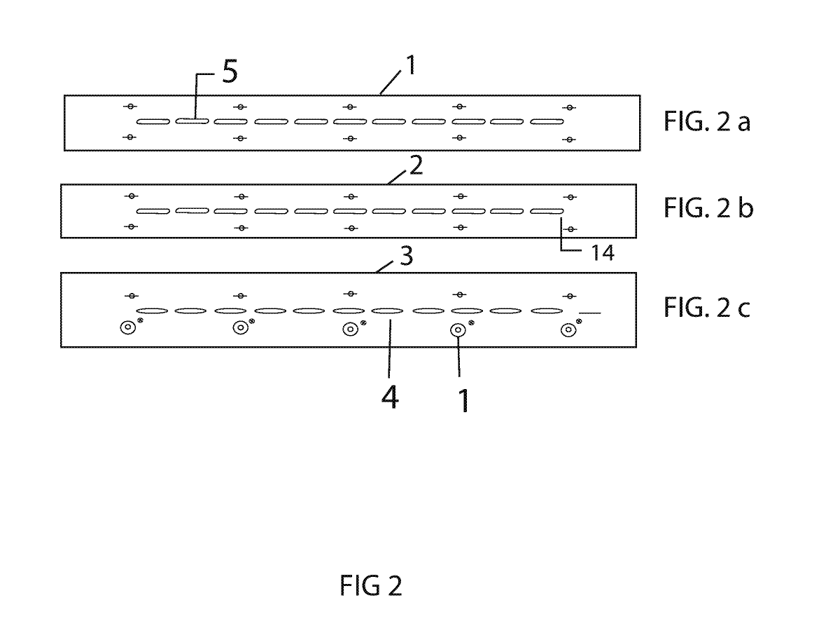

With reference to FIGS. 1-3, the universal perforation system 10 of the present invention includes: a first elongated platform 1; a second elongated platform 2 vertically aligned with the first elongated platform 1; a third elongated platform 3 supporting the first and second elongated platforms.

The platform 1 may be made of a sturdy material, for example, a metal, reinforced plastic, or resin. The first elongated platform 1 may have a width and a length depending on the requirements of the binding machine. In an embodiment, the first platform 1 is about 38.5 cm long, about 4 cm wide, and about 3 mm thick.

The first elongated platform 1 includes holes 12 and a set of male punches 5. Each male punch 5 passes through a respective hole 12 on the first platform 1.

Each one of the holes 12 has a shape in which the length is greater than the width, for example, oval or oblong. The number of holes 12 may depend on the type of binding machine.

The set of punches 5 is constructed to punch through the stack of paper (not shown). In at least one embodiment, the set of punches 5 is operatively connected to a perforation selector mechanism 18.

The set of male punches 5 may have a shape in which the length is greater than the width. The shape of the male punches 5 depends on the shape of the holes 12; thus the punches pass through the holes 12 and produce the puncture of the paper. The set of male punches 5 is secured to the first elongated platform 1. The dimensions of the punchers 5 may depend on the type of binding machine. The punches 5 may not have the same length to prevent the tearing of paper sheets (not shown).

In one embodiment, the set of males punches includes 3 different sizes of punches that are alternatively placed on the first platform 1 in a repeated pattern. For example, large, medium, small, large, medium small. In one embodiment, one size of the punches are about 3.2 cm thick, about 4.75 mm wide, and about 22.5 long.

The second elongated platform 2 includes guiding holes 14 to guide the set of male punches 5. Each hole 14 is perfectly aligned with the hole 12 and the corresponding male punch 5; thus, each male punch 5 easily passes through the hole 14. Each guiding hole 14 has a shape in which the length is greater than the width. The shape of the guiding holes 14 is the same as the shape of the male punches 5 and the holes 12.

The second elongated platform 2 has a length, a width, and a thickness equal to the length, width, and thickness of the first elongated platform 1. The second platform 2 may be made of a sturdy material, for example, a metal, reinforced plastic, or resin.

In a non-operational position, the second platform 2 is vertically separated from the first platform 1 by using vertical bars 16 that are secured to the platform 2. The first elongated platform 1 vertically moves with regards to the second elongated platform 2 from a non-operational position to an operational position.

The bottom side of the third elongated platform 3 stays fixed to a surface on the binding machine (not shown) and the top side is secured to the second elongated platform 2 by using fasteners, for example, screws.

The third elongated platform 3 includes a row of perforations 4 having a shape in which the length is greater than the width, such as an oval or oblong shape. The shape of the perforations 4 is the same as the shape of the guiding holes 14, the male punches 5, and the holes 12; thus, the punches 5 easily passes through the holes 12, the guiding holes 14, and the perforations 4 to punch the paper.

In addition, the third elongated platform includes counter holes 7 to firmly secure the third elongated platform 3 to a surface on the binding machine. The third elongated platform 3 has a length, a width, and a thickness greater than the length, width, and thickness of the first and the second elongated platforms. In an embodiment, the third platform 3 is about 48 cm long, about 5 cm wide, and about 3.5 cm thick.

It is important to have the perforations 4, the holes 12, the guiding holes 14, and the punches 5 having a shape in which the length is greater than the width, such as oval or oblong, since the this characteristic of the shape so all binding are compatible. Without this specific type of shape, the binding will not be compatible will all of the different types of known binding since each binding has its own distance between the loops; thus, the shape needs to have a shape that is in which the length is greater than the width to make easier for pages to turn and insert the coils.

In an embodiment, the punches 5 and the guide holes 14 are manufactured of steel (cold rolled) or any other steel and the counter holes 7 are made of hardened steel. The counter holes 7 are countersink for grub screws.

The spaces (X) that form between each of one of the holes 12, the guiding holes 14, and the perforations 4, in which the length is greater than the width, have equidistant distances metrologically controlled to the three platforms (2), (3) and (4), that facilitates placing the loop or the spiral when introducing the paper sheets.

The perforation system 10 according to the present invention replaces the perforation system on a known binding machine.

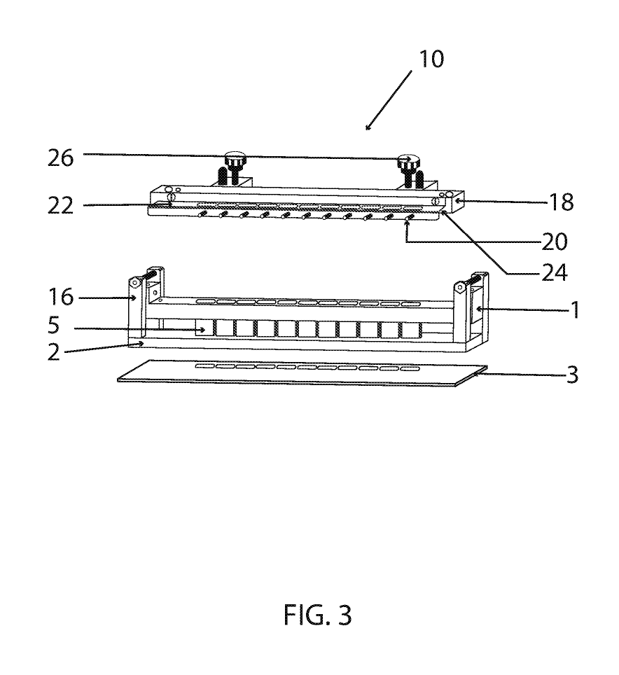

FIG. 3 shows, in the non-operation position, the perforation system 10 including a perforation selector mechanism 18. The perforation selector mechanism 18 is connected to the first elongated platform 1 and includes a perforation selectors 20, a perforation selectors bar 22, a bracket 24, a support device (not shown) for closing the double metallic wire loops; and the screws 26 for leveling of the closing bar.

The present invention also includes a margin selector and a depth selector. The depth selector is located between the second and third platform and is a metal piece that is placed according to the desired margin.

The perforation system 10 is manually activated by turning a bottom on the perforation selector 20, the user may select the punch 5 in which the user would like to prevent the perforation. By pressing the bottom a screw (not shown) is placed in front of the selected punch 5 preventing the perforation of the paper.

The perforation system 10 may be used to perforate papers of different lengths such as letter, legal, A4, A3, or A2 size.

The present invention represents a substantial reduction on consumer's investment and office space, which is very important in homes, private offices, government offices, copy centers, stationery, and printing centers mainly.

Technically, this present invention is based on a principle of replacing all the perforations 4 with a perforation in which the length is greater than the width but without losing the distances and measures that are currently used by current binding systems.

The key factor is that the system uses perforations 4 having the length greater than the width through the punches 5. Likewise, can be used an electric drilling and binding machine as the known (or unknown) provided that incorporates the punches 5 to perform the perforations 4 having the length greater than the width.

Having described the invention, I consider it as a novelty and therefore claim as my property contained in the following clauses:

What is claimed is:

1. A perforation system adapted to be installed on a binding machine, the perforation system comprising:
a first elongated platform;
a second elongated platform aligned with the first elongated platform;
vertical bars to vertically connect the first elongated platform with the second elongated platform;
a third elongated platform having a first end fixed to the second elongated platform and a second end secured to a surface on the binding machine;
the first elongated platform includes holes and a punch passing through each hole, the holes and the punches have a shape with a length greater than a width;
the second elongated platform includes guiding holes aligned with the holes and punches of the first platform, the guiding holes have a shape with a length greater than a width;
the third elongated platform includes a row of perforations having a shape with a length greater a width;
the holes, punches, guiding holes, and perforation have the same shape;
wherein the first elongated platform has a length, width, and thickness;
wherein the second elongated platform has a length, a width, and a thickness equal to the length, width, and thickness of the first elongated platform; and
wherein the third elongated platform has a length, a width, and a thickness greater than the length, width, and thickness of the first and second elongated platforms.

2. The perforation system of claim 1, wherein the perforations, the guiding holes, and the holes are placed at equidistant space from each other on the corresponding platform.

3. The perforation system according to claim 1, wherein the first and second elongated platforms are about 38.5 cm long, about 4 cm wide, and about 3 mm thick, and wherein the third elongated platform is about 48 cm long, about 5 cm wide, and about 3.5 cm thick.

4. The perforation system according to claim 1, wherein each punch has a height of about 3.2 cm, a width of about 4.75 mm, and a length of about 22.5 mm.

5. The perforation system according to claim 1, wherein at least one of the punches has a different length than the rest of the punches.

6. A perforation system adapted to be installed on a binding machine, the perforation system comprising:
a first elongated platform;
a second elongated platform aligned with the first elongated platform;
vertical bars to vertically connect the first elongated platform with the second elongated platform;
a third elongated platform having a first end fixed to the second elongated platform and a second end secured to a surface on the binding machine;
a perforation selector mechanism operatively connected to the punches, the perforation selector mechanism selects the shape of perforation holes on a paper;
the first elongated platform includes holes and a punch passing through each hole, the holes and the punches have a shape with a length greater than a width;
the second elongated platform includes guiding holes aligned with the holes and punches of the first platform, the guiding holes have a shape with a length greater than a width;
the third elongated platform includes a row of perforations having a shape with a length greater a width;
the holes, punches, guiding holes, and perforation have the same shape;
wherein the first elongated platform has a length, width, and thickness;
wherein the second elongated platform has a length, a width, and a thickness equal to the length, width, and thickness of the first elongated platform; and
wherein the third elongated platform has a length, a width, and a thickness greater than the length, width, and thickness of the first and second elongated platforms.
